(19) United States
(12) Patent Application Publication
(10) Pub. No.: US 2026/0070594 A1
(43) Pub. Date: Mar. 12, 2026

(54) HAND TRAILER WITH MULTI-PISTON STRUCTURE

(71) Applicants: Qiang Chen, Shenzhen (CN); Xiang Li, Yongkang (CN); Dongdong Xie, Yuyao (CN)

(72) Inventors: Qiang Chen, Shenzhen (CN); Xiang Li, Yongkang (CN); Dongdong Xie, Yuyao (CN)

(21) Appl. No.: 18/935,706

(22) Filed: Nov. 4, 2024

(30) Foreign Application Priority Data
Sep. 6, 2024 (CN) 2024221836671

(51) Int. Cl. B62B 3/00; B62B 3/02; B62B 5/06

(52) U.S. Cl. CPC B62B 3/007; B62B 3/025; B62B 5/064; B62B 2205/06; B62B 2205/104; B62B 2301/05

(57) ABSTRACT

A hand trailer with multi-piston structure includes a fence assembly, a bottom fork assembly, wheel fixing and disassembling assemblies and a pull rod assembly. The fence assembly is a regular four-sided connection structure, and uses first piston structures and second piston structures as connection nodes, and the first piston structures and the second piston structures are arranged in parallel; a top of each first piston structure is riveted with a bottom of a corresponding second piston structure by a first inclined rod, a bottom of each first piston structure is riveted with a top of a corresponding second piston structure by a second inclined rod. Technical points of the hand trailer with multi-piston structure are that a new folding structure, a new bottom support structure and a new wheel installation structure are adopted, so that a load-bearing capacity and a folding and packing volume of the product are obviously improved.

### CROSS-REFERENCE TO RELATED APPLICATION

This application claims priority to Chinese Patent Application No. 202422183667.1, filed on Sep. 6, 2024, which is herein incorporated by reference in its entirety.

### TECHNICAL FIELD

The disclosure relates to the technical field of folding structures, and more particularly to a hand trailer with multi-piston structure.

### BACKGROUND

Hand trailer is a small handcart, which is mainly used to carry goods or articles. The hand trailer is usually pushed or pulled by one person and is widely used in many occasions such as home, warehouse, supermarket and logistics center.

In order to overcome disadvantages of the related art, a purpose of the disclosure is to provide a hand trailer with multi-piston structure, which adopts a new folding structure, a new bottom support structure and a new wheel installation structure, so that a load-bearing capacity and a folding and packing volume of the hand trailer are obviously improved. In the disclosure, piston telescopic structures are connected to inclined rods to form an expandable and foldable subunit, and multiple subunits are connected in pairs to form an integral linkage, expandable and closeable fence structure.

### SUMMARY

The above technical purpose of the disclosure is achieved through the following technical solutions.

A hand trailer with multi-piston structure includes: a fence assembly, a bottom fork assembly, wheel fixing and disassembling assemblies and a pull rod assembly. The fence assembly is a regular four-sided connection structure, and uses first piston structures and second piston structures as connection nodes, and the first piston structures and the second piston structures are arranged in parallel. A top of each of the first piston structures is riveted with a bottom of a corresponding one of the second piston structures by a first inclined rod, a bottom of each of the first piston structures is riveted with a top of a corresponding one of the second piston structures by a second inclined rod, and the first inclined rod and the second inclined rod are staggered and riveted by center holes of the first inclined rod and the second inclined rod, to form a piston structure subunit. Each side wall of the fence assembly includes at least two piston structure subunits, and adjacent two of the at least two piston structure subunits share a piston rod (i.e., piston structure, such as the first piston structure or the second piston structure) to achieve linkage. A front wall and a rear wall of the fence assembly each include at least one piston structure subunit, and the front wall and each side wall of the fence assembly share a piston rod (i.e., piston structure, such as the first piston structure or the second piston structure) and the rear wall and each side wall of the fence assembly share a piston rod (i.e., piston structure, such as the first piston structure or the second piston structure), to achieve linkage.

In an embodiment, the bottom fork assembly includes: a first-layer bottom support structure and a second-layer automatic folding bottom support structure. The first-layer bottom support structure includes four first-layer bottom fork support rods, first-layer bottom fork connection iron fittings, cylindrical pins and a central connection member. An end of each of the four first-layer bottom fork support rods is welded with the first-layer bottom fork connection iron fitting, and each of the four first-layer bottom fork support rods is connected to a respective one of four bottom corners of the fence assembly by the first-layer bottom fork connection iron fitting. The other end of each of the four first-layer bottom fork support rods is perforated and inserted with the cylindrical pin, and the cylindrical pin is inserted into a slot of the central connection member. The four first-layer bottom fork support rods rotate upwards under pulling of the central connection member when the four first-layer bottom fork support rods are folded, and the four first-layer bottom fork support rods are prevented from further downward movement is prevented when the four first-layer bottom fork support rods are leveled to a horizontal plane, to thereby achieve supporting and bearing.

In an embodiment, a cover plate is disposed on the central connection member, and is connected to the central connection member by self-tapping screws, to prevent the four first-layer bottom fork support rods from disassembling from the central connection member after folding.

In an embodiment, the second-layer automatic folding bottom support structure includes two second-layer bottom fork support rods, second-layer bottom fork connection iron fittings, two second-layer bottom fork rotation iron fittings and a folding torsion spring. An end of each of the two second-layer bottom fork support rods is welded with the second-layer bottom fork connection iron fitting, and each of the two second-layer bottom fork support rods is connected to a bottom of one of the first piston structures and the second piston structures located in a middle of each side wall of the fence assembly by the second-layer bottom fork connection iron fitting. The other ends of the two second-layer bottom fork support rods are welded with the two second-layer bottom fork rotation iron fittings, the folding torsion spring is disposed between the two second-layer bottom fork rotation iron fittings, and is riveted with the two second-layer bottom fork rotation iron fittings.

In an embodiment, tops of the two second-layer bottom fork rotation iron fittings just contact when the two second-layer bottom fork rotation iron fittings move downwards to be on a same line, to prevent the two second-layer bottom fork support rods from moving downwards continuously, to thereby achieve supporting and bearing.

In an embodiment, each of the wheel fixing and disassembling assemblies is inserted into and fixed to a piston structure lower fixing rod located on one of the four bottom corners of the fence assembly by an inner sleeve. An outside of the piston structure lower fixing rod is sleeved with an outer fixing sleeve, and the piston structure lower fixing rod is riveted with the outer fixing sleeve by an opening on an upside of the outer fixing sleeve. The outer fixing sleeve defines a square motion slot, and a fixing button is embedded into the square motion slot. A middle of the fixing button defines a cavity, and a return spring is disposed in the cavity.

In an embodiment, the fixing button disposed with the return spring is inserted into the square motion slot of the outer fixing sleeve, and the fixing button disposed with the return spring is riveted with the outer fixing sleeve by a rivet using an up-down connection method, to make the fixing button reciprocate within a certain range.

In an embodiment, the pull rod assembly includes a main pull rod and two auxiliary pull rods, an end of each of the two auxiliary pull rods is movably connected to the main pull rod, the other ends of the two auxiliary pull rods are movably connected to the piston structure lower fixing rods on a left side wall of the fence assembly.

In summary, the disclosure has the following beneficial effects.
1. The disclosure adopts a new folding structure, a new bottom support structure and a new wheel installation structure, so that a load-bearing capacity and a folding and packing volume of the hand trailer are obviously improved. In the disclosure, piston telescopic structures are connected to inclined rods to form an expandable and foldable subunit, and multiple subunits are connected in pairs to form an integral linkage, expandable and closeable fence structure.
2. The bottom of the fence structure innovatively uses the bottom support structure which is connected with the upper and lower layers independently but can be stressed at the same time, so as to greatly improve the bearing capacity and durability of the hand trailer.
3. At the four bottom corners of the whole structure, devices with fixed and disassembled wheels are constructed, which can be easily disassembled and cleaned by consumers, and can also significantly reduce the packing size and facilitate transportation.

### BRIEF DESCRIPTION OF DRAWINGS

FIG. 1 illustrates a schematic structural diagram of overall assembly of a hand trailer with multi-piston structure according to an embodiment of the disclosure.

FIG. 2 illustrates a schematic structural diagram of a fence assembly of the hand trailer with multi-piston structure according to an embodiment of the disclosure.

FIG. 3 illustrates a schematic structural diagram of a piston structure subunit of the hand trailer with multi-piston structure according to an embodiment of the disclosure.

FIG. 4 illustrates a schematic structural diagram of a first-layer bottom support structure of a bottom fork assembly of the hand trailer with multi-piston structure according to an embodiment of the disclosure.

FIG. 5 illustrates a schematic diagram of connection between first-layer bottom fork support rods and a central connection member according to an embodiment of the disclosure.

FIG. 6 illustrates a schematic structural diagram of a second-layer automatic folding bottom support structure of the bottom fork assembly of the hand trailer with multi-piston structure according to an embodiment of the disclosure.

FIG. 7 illustrates an exploded schematic structural diagram of a wheel fixing and disassembling assembly of the hand trailer with multi-piston structure according to an embodiment of the disclosure.

FIG. 8 illustrates a schematic structural diagram of a part of the wheel fixing and disassembling assembly of the hand trailer with multi-piston structure according to an embodiment of the disclosure.

List of reference number:
1—fence assembly; 101—first piston structure; 102—second piston structure; 103—first inclined rod; 104—second inclined rod; 2—bottom fork assembly; 201—first-layer bottom support structure; 2011—first-layer bottom fork support rod; 2012—first-layer bottom fork connection iron fitting; 2013—central connection member; 2014—cover plate; 2015—slot; 2016—cylindrical pin; 2017—self-tapping screw; 202—second-layer automatic folding bottom support structure; 2021—second-layer bottom fork support rod; 2022—second-layer bottom fork connection iron fitting; 2023—second-layer bottom fork rotation iron fitting; 2024—folding torsion spring; 3—wheel fixing and disassembling assembly; 301—inner sleeve; 302—piston structure lower fixing rod; 303—outer fixing sleeve; 304—fixing button; 305—return spring; 306—rivet; 4—pull rod assembly; 401—main pull rod; 402—auxiliary pull rod.

### DETAILED DESCRIPTION OF EMBODIMENTS

The disclosure will be further described in details in conjunction with drawings below.

The same components are represented by the same reference numbers. It should be noted that terms “front”, “rear”, “left”, “right”, “up” and “down” used in the following description refer to directions in the drawings, while terms “bottom” and “top”, “inside” and “outside” respectively refer to directions facing towards or facing away from a geometric center of a specific component.

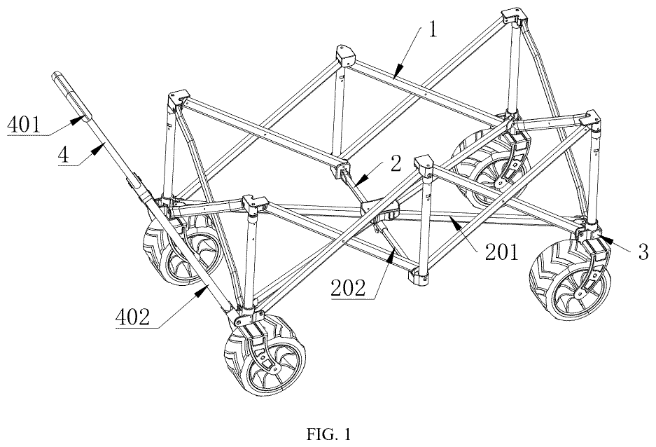

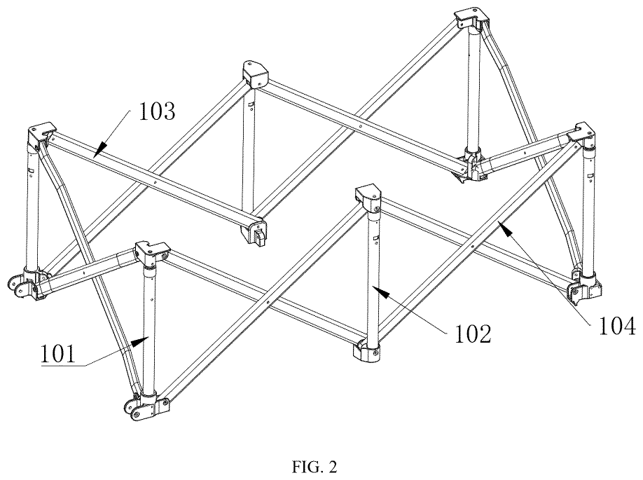

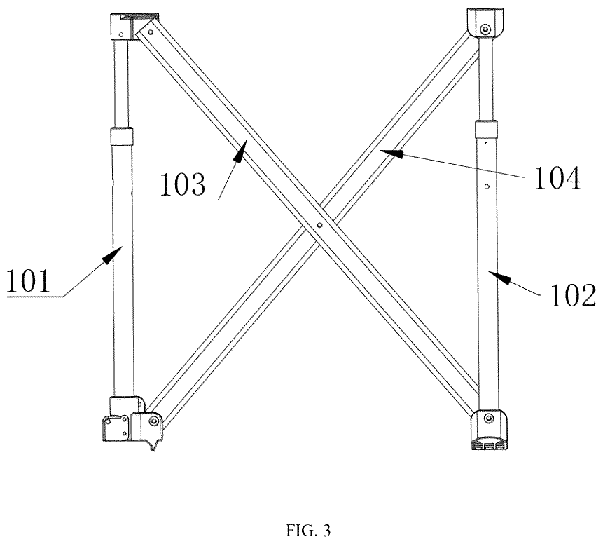

As shown in FIGS. 1-3, a hand trailer with multi-piston structure of an embodiment of the disclosure includes: a fence assembly 1, a bottom fork assembly 2, wheel fixing and disassembling assemblies 3 and a pull rod assembly 4. The fence assembly 1 is a regular four-sided connection structure, and uses first piston structures 101 and second piston structures 102 as connection nodes, and the first piston structures 101 and the second piston structures 102 are arranged in parallel. A top of each of the first piston structures 101 is riveted with a bottom of a corresponding one of the second piston structures 102 by a first inclined rod 103, a bottom of each of the first piston structures 101 is riveted with a top of a corresponding one of the second piston structures 102 by a second inclined rod 104, and the first inclined rod 103 and the second inclined rod 104 are staggered and riveted by center holes of the first inclined rod 103 and the second inclined rod 104, to form a piston structure subunit. Each side wall of the fence assembly 1 includes at least two piston structure subunits, and two adjacent piston structure subunits share a piston structure (i.e., first piston structure 101 or second piston structure 102) to achieve linkage. A front wall and a rear wall of the fence assembly 1 each include at least one piston structure subunit, and the front wall and the side wall of the fence assembly 1 share a piston structure (i.e., first piston structure 101 or second piston structure 102) and the rear wall and the side wall of the fence assembly 1 share a piston structure (i.e., first piston structure 101 or second piston structure 102), to achieve linkage. Each piston structure may include a piston structure upper fixing rod and a piston structure lower fixing rod 302, the piston structure lower fixing rod 302 is sleeved on the piston structure upper fixing rod, and is in movable connection with the piston structure upper fixing rod.

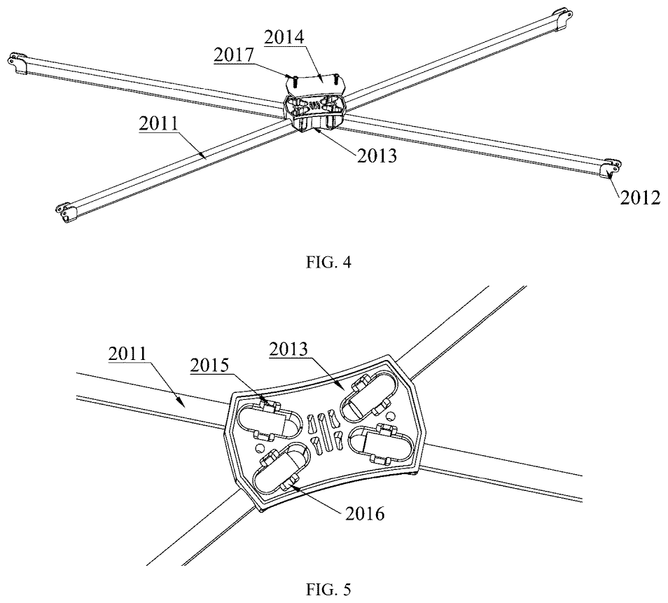

As shown in FIG. 1 and FIG. 4, the bottom fork assembly 2 includes a first-layer bottom support structure 201 and a second-layer automatic folding bottom support structure 202. The first-layer bottom support structure 201 includes four first-layer bottom fork support rods 2011, first-layer bottom fork connection iron fittings 2012, cylindrical pins 2016 and a central connection member 2013. An end of each of the first-layer bottom fork support rods 2011 is welded with the first-layer bottom fork connection iron fitting 2012, and each of the first-layer bottom fork support rods 2011 is connected to a respective one of four bottom corners of the fence assembly 1 by the first-layer bottom fork connection iron fitting 2012. The other end of each of the first-layer bottom fork support rods 2011 is perforated and inserted with the cylindrical pin 2016, and the cylindrical pin 2016 is inserted into a slot 2015 of the central connection member 2013. The first-layer bottom fork support rods 2011 rotate upwards under pulling of the central connection member 2013 when the four first-layer bottom fork support rods 2011 are folded, and the first-layer bottom fork support rods 2011 are prevented from further downward movement when the first-layer bottom fork support rods 2011 are leveled to a horizontal plane, to thereby achieve supporting and bearing.

As shown in FIG. 1 and FIG. 4, a cover plate 2014 is disposed on the central connection member 2013, and is connected to the central connection member 2013 by self-tapping screws 2017, to prevent the first-layer bottom fork support rods 2011 from disassembling from the central connection member 2013 after folding.

As shown in FIG. 1 and FIG. 5, the second-layer automatic folding bottom support structure 202 includes two second-layer bottom fork support rods 2021, second-layer bottom fork connection iron fittings 2022, two second-layer bottom fork rotation iron fittings 2023 and a folding torsion spring 2024. An end of each of the second-layer bottom fork support rods 2021 is welded with the second-layer bottom fork connection iron fitting 2022, and each of the second-layer bottom fork support rods 2021 is connected to a bottom of one of the first piston structures 101 and the second piston structures 102 located in a middle of the side wall of the fence assembly 1 by the second-layer bottom fork connection iron fitting 2022. The other ends of the second-layer bottom fork support rods 2021 are welded with the two second-layer bottom fork rotation iron fittings 2023, the folding torsion spring 2024 is disposed between the two second-layer bottom fork rotation iron fittings 2023, and is riveted with the two second-layer bottom fork rotation iron fittings 2023.

As shown in FIG. 1 and FIG. 5, tops of the two second-layer bottom fork rotation iron fittings 2023 just contact when the two second-layer bottom fork rotation iron fittings 2023 move downwards to be on a same line, to prevent the second-layer bottom fork support rods 2021 from moving downwards continuously, to thereby achieve supporting and bearing.

When the first-layer bottom support structure 201 is unfolded to be in a horizontal state, the first-layer bottom support structure 201 is just in contact with the second-layer automatic folding bottom support structure 202, to achieve common supporting and bearing. When the first-layer bottom support structure 201 is folded upward, the folding torsion spring 2024 of the second-layer automatic folding bottom support structure 202 makes the first-layer bottom support structure 201 deflect upward to some extent, so that the two sets of bottom support structures (i.e., the first-layer bottom support structure 201 and the second-layer automatic folding bottom support structure 202) can be effectively folded although they are not linked.

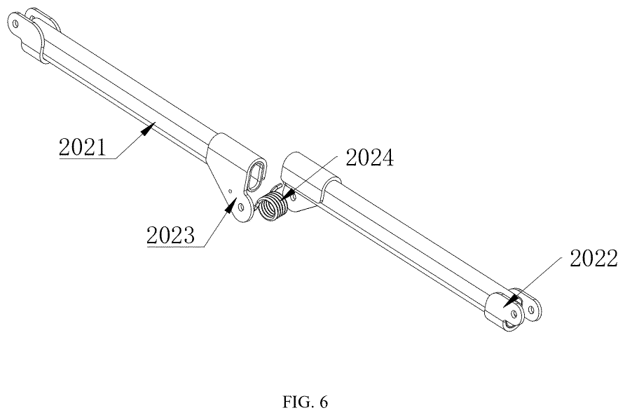

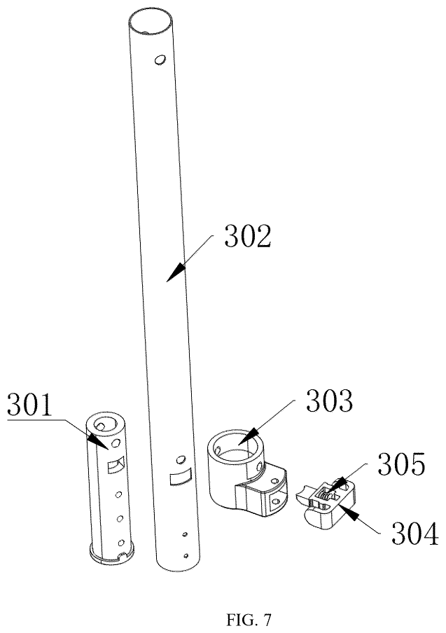

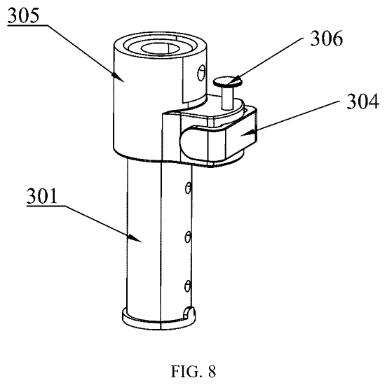

As shown in FIG. 1 and FIG. 6, each of the wheel fixing and disassembling assemblies 3 is inserted into and fixed to a piston structure lower fixing rod 302 on one of the four bottom corners of the fence assembly 1 by an inner sleeve 301. An outside of the piston structure lower fixing rod 302 is sleeved with an outer fixing sleeve 303, and the piston structure lower fixing rod 302 is riveted with the outer fixing sleeve 303 by an opening on an upside of the outer fixing sleeve 303. The outer fixing sleeve 303 defines a square motion slot, and a fixing button 304 is embedded into the square motion slot. A middle of the fixing button 304 defines a cavity, and a return spring 305 is disposed in the cavity.

As shown in FIG. 1 and FIG. 6, the fixing button 304 disposed with the return spring 305 is inserted into the square motion slot of the outer fixing sleeve 303, and the fixing button 304 disposed with the return spring 305 is riveted with the outer fixing sleeve 303 by a rivet 306 using an up-down connection method, to make the fixing button 304 reciprocate within a certain range.

The process of reciprocating motion ensures that a front end of the fixing button 304 can be extended into the inner sleeve 301 and withdrawn from the inner sleeve 301, so that a wheel axle in the inner sleeve 301 can be locked (i.e., fixing the wheels), and the wheel axle can be unlocked (i.e., disassembling the wheels) without contact with the wheel axle.

As shown in FIG. 1, the pull rod assembly 4 includes a main pull rod 401 and two auxiliary pull rods 402, an end of each of the two auxiliary pull rods 402 is movably connected to the main pull rod 401, the other ends of the two auxiliary pull rods 402 are movably connected to the piston structure lower fixing rods 302 on a left side wall of the fence assembly 1.

A specific implementation process is as follows: the pull rod assembly 4 can be used to push or pull the hand trailer to move. The fence assembly 1 can be pushed or pulled to unfold or fold each piston structure subunit, to thereby adjust a volume of the hand trailer. When the first-layer bottom support structure 201 is unfolded to be in a horizontal state, the first-layer bottom support structure 201 is just in contact with the second-layer automatic folding bottom support structure 202, to achieve common supporting and bearing. When the first-layer bottom support structure 201 is folded upward, the folding torsion spring 2024 of the second-layer automatic folding bottom support structure 202 makes the first-layer bottom support structure 201 deflect upward to some extent, so that the two sets of bottom support structures (i.e., the first-layer bottom support structure 201 and the second-layer automatic folding bottom support structure 202) can be effectively folded although they are not linked.

In addition, the fixing button 304 disposed with the return spring 305 is inserted into the square motion slot of the outer fixing sleeve 303, and the fixing button 304 disposed with the return spring 305 is riveted with the outer fixing sleeve 303 by the rivet using the up-down connection method, to make the fixing button 304 reciprocate within a certain range. The process of reciprocating motion ensures that the front end of the fixing button 304 can be extended into the inner sleeve 301 and withdrawn from the inner sleeve 301, so that a wheel axle in the inner sleeve 301 can be locked (i.e., fixing the wheels), and the wheel axle can be unlocked (i.e., disassembling the wheels) without contact with the wheel axle.

The above shows and describes a basic principle, main features and advantages of the disclosure. It should be understood by those skilled in the art that the disclosure is not limited by the aforementioned embodiments, and the descriptions in the aforementioned embodiments and specification only illustrate the principle of the disclosure. Under a premise of not departing from a spirit and a scope of the disclosure, there will be various changes and improvements in the disclosure, which fall within the scope of the disclosure to be protected. The scope of protection require by the disclosure is defined by claims and equivalents thereof.

What is claimed is:

1. A hand trailer with multi-piston structure, comprising: a fence assembly (1), a bottom fork assembly (2), wheel fixing and disassembling assemblies (3) and a pull rod assembly (4); wherein the fence assembly (1) is a regular four-sided connection structure, and uses first piston structures (101) and second piston structures (102) as connection nodes, and the first piston structures (101) and the second piston structures (102) are arranged in parallel; a top of each of the first piston structures (101) is riveted with a bottom of a corresponding one of the second piston structures (102) by a first inclined rod (103), a bottom of each of the first piston structures (101) is riveted with a top of the corresponding one of the second piston structures (102) by a second inclined rod (104), and the first inclined rod (103) and the second inclined rod (104) are staggered and riveted by center holes of the first inclined rod (103) and the second inclined rod (104), to form a piston structure subunit; each side wall of the fence assembly (1) comprises at least two piston structure subunits, and adjacent two of the at least two piston structure subunits share one of the first piston structures (101) and the second piston structures (102) to achieve linkage; and a front wall and a rear wall of the fence assembly (1) each comprise at least one piston structure subunit, and the front wall and each side wall of the fence assembly (1) share one of the first piston structures (101) and the second piston structures (102) and the rear wall and each side wall of the fence assembly (1) share one of the first piston structures (101) and the second piston structures (102), to achieve linkage.

2. The hand trailer with multi-piston structure as claimed in claim 1, wherein the bottom fork assembly (2) comprises a first-layer bottom support structure (201) and a second-layer automatic folding bottom support structure (202); the first-layer bottom support structure (201) comprises four first-layer bottom fork support rods (2011); an end of each of the four first-layer bottom fork support rods (2011) is welded with a first-layer bottom fork connection iron fitting (2012), and each of the four first-layer bottom fork support rods (2011) is connected to a respective one of four bottom corners of the fence assembly (1) by the first-layer bottom fork connection iron fitting (2012); the other end of each of the four first-layer bottom fork support rods (2011) is perforated and inserted with a cylindrical pin (2016), and the cylindrical pin (2016) is inserted into a slot (2015) of a central connection member (2013); and the four first-layer bottom fork support rods (2011) rotate upwards under pulling of the central connection member (2013) when the four first-layer bottom fork support rods (2011) are folded, and the four first-layer bottom fork support rods (2011) are prevented from further downward movement when the four first-layer bottom fork support rods (2011) are leveled to a horizontal plane, to thereby achieve supporting and bearing.

3. The hand trailer with multi-piston structure as claimed in claim 2, wherein a cover plate (2014) is disposed on the central connection member (2013), and is connected to the central connection member (2013) by self-tapping screws (2017), to prevent the four first-layer bottom fork support rods (2011) from disassembling from the central connection member (2013) after folding.

4. The hand trailer with multi-piston structure as claimed in claim 3, wherein the second-layer automatic folding bottom support structure (202) comprises two second-layer bottom fork support rods (2021); an end of each of the two second-layer bottom fork support rods (2021) is welded with a second-layer bottom fork connection iron fitting (2022), and each of the two second-layer bottom fork support rods (2021) is connected to a bottom of one of the first piston structures (101) and the second piston structures (102) located in a middle of each side wall of the fence assembly (1) by the second-layer bottom fork connection iron fitting (2022); and the other ends of the two second-layer bottom fork support rods (2021) are welded with two second-layer bottom fork rotation iron fittings (2023), a folding torsion spring (2024) is disposed between the two second-layer bottom fork rotation iron fittings (2023), and is riveted with the two second-layer bottom fork rotation iron fittings (2023).

5. The hand trailer with multi-piston structure as claimed in claim 4, wherein tops of the two second-layer bottom fork rotation iron fittings (2023) just contact when the two second-layer bottom fork rotation iron fittings (2023) move downwards to be on a same line, to prevent the two second-layer bottom fork support rods (2021) from moving downwards continuously, to thereby achieve supporting and bearing.

6. The hand trailer with multi-piston structure as claimed in claim 1, wherein each of the wheel fixing and disassembling assemblies (3) is inserted into and fixed to a piston structure lower fixing rod (302) located on one of four bottom corners of the fence assembly (1) by an inner sleeve (301); an outside of the piston structure lower fixing rod (302) is sleeved with an outer fixing sleeve (303), and the piston structure lower fixing rod (302) is riveted with the outer fixing sleeve (303) by an opening on an upside of the outer fixing sleeve (303); the outer fixing sleeve (303) defines a square motion slot, and a fixing button (304) is embedded into the square motion slot; and a middle of the fixing button (304) defines a cavity, and a return spring (305) is disposed in the cavity.

7. The hand trailer with multi-piston structure as claimed in claim 6, wherein the fixing button (304) disposed with the return spring (305) is inserted into the square motion slot of the outer fixing sleeve (303), and the fixing button (304) disposed with the return spring (305) is riveted with the outer fixing sleeve (303) by a rivet (306) using an up-down connection method, to make the fixing button (304) reciprocate within a certain range.

8. The hand trailer with multi-piston structure as claimed in claim 1, wherein the pull rod assembly (4) comprises a main pull rod (401) and two auxiliary pull rods (402), an end of each of the two auxiliary pull rods (402) is movably connected to the main pull rod (401), the other ends of the two auxiliary pull rods (402) are movably connected to piston structure lower fixing rods (302) on a left side wall of the fence assembly (1).
